(19) United States
(12) Patent Application Publication
(10) Pub. No.: US 2013/0031770 A1
(43) Pub. Date: Feb. 7, 2013

(54) CONNECTION SYSTEM FOR ELONGATE HOLLOW BODIES AND METHOD FOR CONNECTING ELONGATE HOLLOW BODIES

(71) Applicants: Manuel MAYER, Ehingen (DE); Alfred HUBER, Maselheim (DE); Roland HOEFLE, Friedrichshafen (DE)

(72) Inventors: Manuel MAYER, Ehingen (DE); Alfred HUBER, Maselheim (DE); Roland HOEFLE, Friedrichshafen (DE)

(73) Assignee: DIEHL AIRCABIN GMBH, Laupheim (DE)

(21) Appl. No.: 13/563,307

(22) Filed: Jul. 31, 2012

(30) Foreign Application Priority Data
Aug. 4, 2011 (DE) 102011109423.0
Oct. 8, 2011 (DE) 102011115447.0

(51) Int. Cl. F16L 21/08; B23P 11/00; F16L 21/02

(52) U.S. Cl. 29/525.01; 285/81

(57) ABSTRACT

The invention relates to a connection system for elongate hollow bodies (22), in particular pipes or shallow ducts in an aircraft, which includes a first connecting element (2) and a second connecting element (3) which may be mounted on mutually facing ends of elongate hollow bodies (22), wherein the first connecting element (2) includes at least one projecting element (6) which is arranged in a radial direction and, in the event of being pushed together, may be introduced into a corresponding recess (7) in the second connecting element (3), wherein between the first connecting element (2) and the second connecting element (3) there is arranged a locking means (12) which provides a detachable connection between the first connecting element (2) and the second connecting element (3). Furthermore, the invention relates to a method for connecting two elongate hollow bodies, in particular pipes or shallow ducts in an aircraft.

### FIELD OF THE INVENTION

The invention relates to a connection system for elongate hollow bodies, in particular pipes or shallow ducts in an aircraft. Furthermore, the invention relates to a method for connecting elongate hollow bodies, in particular pipes or shallow ducts in an aircraft.

### BACKGROUND OF THE INVENTION

Circular pipes are used in numerous ways in the passenger cabin of aircrafts. For example, air intakes for air conditioning systems in the passenger cabin are often formed by pipe sections which are spaced by only a small distance and which frequently have to be put together without the possibility of providing corresponding holder positions. This necessitates a reliable connecting mechanism which must be lightweight and may also be operated securely under narrow spatial constraints.

One way of creating a connecting mechanism is to use V-shaped flanges which are each glued to the outer faces of circular pipe ends and then tensioned to a clamp having a V-shaped internal geometry, as a result of which an internal gasket is compressed and the pipes are firmly connected to each other.

### SUMMARY OF THE INVENTION

The object of the invention is to provide a connection system for elongate hollow bodies of the type mentioned at the outset and to specify a method for connecting elongate hollow bodies, this connection system and this method being able to connect hollow bodies to a cross-sectional surface which is to be made as flexible as possible and all having a construction which takes up little space.

This object is achieved, in a first aspect, by the features of Patent claim 1. Further advantageous embodiments of the invention each form a subject of the subclaims. The latter may be combined with one another where this is technologically useful. The description provides additional characterization and specification of the invention, in particular in conjunction with the drawing.

The connection system according to the invention for elongate hollow bodies, in particular pipes or shallow ducts in an aircraft, includes a first connecting element and a second connecting element which may be mounted on mutually facing ends of elongate hollow bodies. The first connecting element includes at least one projecting element which is arranged in a radial direction and, in the event of being pushed together, may be introduced into a corresponding recess in the second connecting element. Between the first connecting element and the second connecting element there is arranged a locking means which provides a detachable connection between the first connecting element and the second connecting element.

The connection system according to the invention reduces the space required when the elongate hollow bodies are installed and uninstalled in that no clamps or flanges are provided. As a result it becomes possible to bring the two elongate hollow bodies together laterally in a manner in which only a small space is required, since for example no elements have to be guided around and applied to the elongate hollow bodies in the joined condition. Furthermore, after installation the two hollow bodies can no longer be twisted in relation to one another, since there are no rotationally symmetrical components such as clamps or brackets. Further, the connection system may be made very lightweight, such that for example when pipes are used in an aircraft there is no possibility of the resonant frequencies creating a nuisance at low frequencies.

According to an embodiment of the invention, the projecting element covers part of the outer periphery of the first connecting element, preferably over one side.

Accordingly, the corresponding elements are made in the shape of half-shells such that the recess and the projecting element may easily be introduced into one another.

According to a further embodiment of the invention, it is provided for the first connecting element to have on its outer edge, outside the projecting element, a further recess into which a corresponding further projecting element on the second connecting element may be introduced.

Accordingly, a connection over almost the entire periphery is produced between the first and the second connecting element.

According to a further embodiment of the invention, the projecting element and the recess are shaped such that when they are pushed together an axial offset is produced in the direction of the hollow body.

In this way, friction between the first connecting element and the second connecting element is reduced.

According to a further embodiment of the invention, on the second connecting element there is mounted a gasket whereof the sealing surface faces the first connecting element.

Furthermore, the gasket may be clamped in an undercut opening in the second connecting element.

The gasket may be formed as an extruded hollow body, preferably of silicone.

The gasket makes it possible to form a seal between the two elongate hollow bodies at the time of assembly. This ensures that the gasket cannot fall out during assembly. Further, the gasket is fully compressed only once the locking means is in the closed position.

According to a further embodiment of the invention, it is provided for the locking means to be a quarter-turn lock arranged on the second connecting element.

A quarter-turn lock, also called a Dzus fastener, is a lock which has proved successful in aircraft construction and may be operated without tools, for example by way of a corresponding wing-head element. For this, the lock may be arranged in the direction of uninstalling, in order to facilitate operation during assembly.

In a further embodiment of the invention, the quarter-turn lock reaches into an elongate body, preferably a wire, which is arranged in an outer region of the first connecting element.

On their underside, quarter-turn locks have hook-shaped elements which as a result of being turned can reach into a wire loop in order to make a secure connection.

At the same time, a conical spring provides for a determinable restoring force, such that if the lock does not engage fully it springs into the open position. This directly indicates to the user that locking has not been performed.

The elongate hollow bodies may be of circular or elliptical cross-section or may take the form of a shallow duct.

By dispensing with rotationally symmetrical components such as clamps or flanges, the connecting system may be used for any desired cross-sections of the elongate hollow bodies. Here, the locking means may equally be arranged on the shorter or on the longer side of the elongate hollow bodies.

The first connecting element and the second connecting element may be made by means of an injection moulding method.

In this way, it is possible to provide a connection system which is of low weight and moreover can be made in large numbers at low cost.

In a further embodiment of the invention, the first connecting element and the second connecting element are connected to the elongate hollow bodies by means of an adhesive.

This procedure enables a simple assembly of the connecting elements to the elongate hollow bodies.

Furthermore, an aircraft air conditioning system having pipes or shallow ducts which are at least in some cases provided with a connection system according to the invention is specified.

Further, an aircraft having an air conditioning system which includes pipes or shallow ducts which are at least in some cases provided with a connection system according to the invention is specified.

A method for connecting two elongate hollow bodies comprises providing a first connecting element which includes a projecting element which is arranged in a radial direction. A second connecting element which includes a recess corresponding to the projecting element is provided. Once the first connecting element and the second connecting element have been mounted on mutually facing ends of elongate hollow bodies, the first and the second connecting element are pushed together in a radial direction. Between the first connecting element and the second connecting element there is arranged a locking means. In a last step, the locking means is then closed such that a detachable connection is made between the first connecting element and the second connecting element.

### BRIEF DESCRIPTION OF THE DRAWINGS

Some exemplary embodiments will be explained in more detail below with reference to the drawings, in which:

FIG. 1 shows a schematic illustration of a connection system according to the invention,

FIG. 2 shows a view of a connection system according to the invention before it is joined,

FIG. 3 shows a view of a connection system according to the invention after it is joined,

FIG. 4 shows a detail view of a region of FIG. 3,

FIG. 5 shows a further detail view of a region of FIG. 3,

FIG. 6 shows a further detail view of a region of FIG. 1,

FIG. 7 shows a cross-sectional view of the connection system before it is closed,

FIG. 8 shows a cross-sectional view of the connection system after it is closed,

FIG. 9 shows a further cross-sectional view of the connection system, including a gasket, and

FIG. 10 shows a cross-sectional view through elongate hollow bodies.

### DETAILED DESCRIPTION OF EXEMPLARY EMBODIMENTS

In the figures, like or functionally equivalent components are provided with like reference numerals.

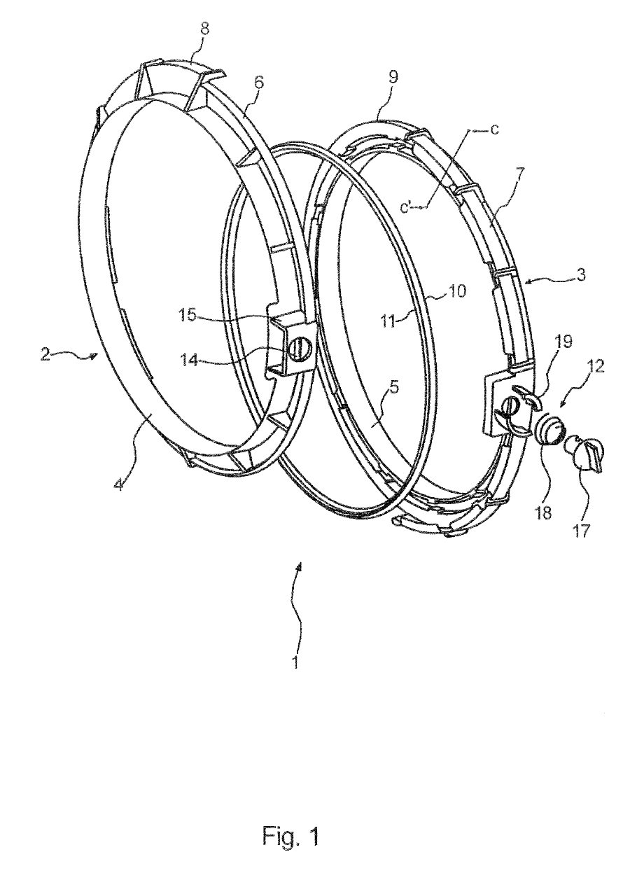

A first embodiment of the invention will be explained below with reference to FIG. 1. FIG. 1 shows a connection system 1 which serves to connect two elongate hollow bodies. Possible elongate hollow bodies (not shown in FIG. 1) which may be used are for example pipes or shallow ducts for a ventilation system or air conditioning system in an aircraft.

The connection system 1 includes a first connecting element 2 and a second connecting element 3. The first connecting element 2 and the second connecting element 3 are in the form of a ring and may be mounted on mutually facing ends of the elongate hollow bodies to make a connection between the elongate hollow bodies. The first connecting element 2 includes a first inner face 4 whereof the shape corresponds to that of the elongate hollow body. Further, the second connecting element 3 includes a second inner face 5 whereof the shape corresponds similarly to the geometry of the elongate hollow body. The inner face 4 and the inner face 5 may be connected to the ends of the elongate hollow bodies by means of an adhesive.

The first connecting element 2 includes a projecting element 6 which is arranged in the radial direction and may be introduced into a corresponding recess 7 in the second connecting element 3.

In the embodiment shown in FIG. 1, the projecting element 6 covers the outer periphery of the first connecting element 2 over one side. The first connecting element 2 has on its outer edge, outside the projecting element 6, a further recess 8 into which a corresponding further projecting element 9 on the second connecting element 3 may be introduced. Accordingly, the corresponding components comprising the projecting element 6 and the recess 7, and the further projecting element 9 and the further recess 8, are made in the shape of half-shells such that they may easily be introduced into one another and a connection over almost the entire periphery is produced between the first connecting element 2 and the second connecting element 3.

On the second connecting element 3 there is mounted a gasket 10 whereof the sealing surface 11 faces the first connecting element 2 such that in the joined condition the connection between the first connecting element 2 and the second connecting element 3 is sealed.

Between the first connecting element 2 and the second connecting element 3 there is arranged a locking means which makes a detachable connection between the first connecting element 2 and the second connecting element 3. Possible embodiments of the locking means 12 are explained below. It is provided for the gasket 10 to be fully compressed only once the locking means 12 is in the closed position.

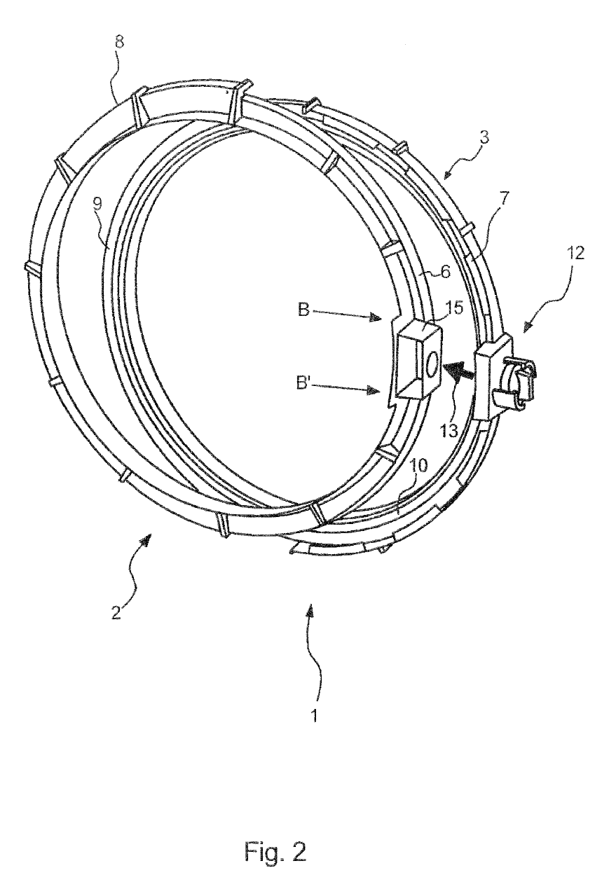

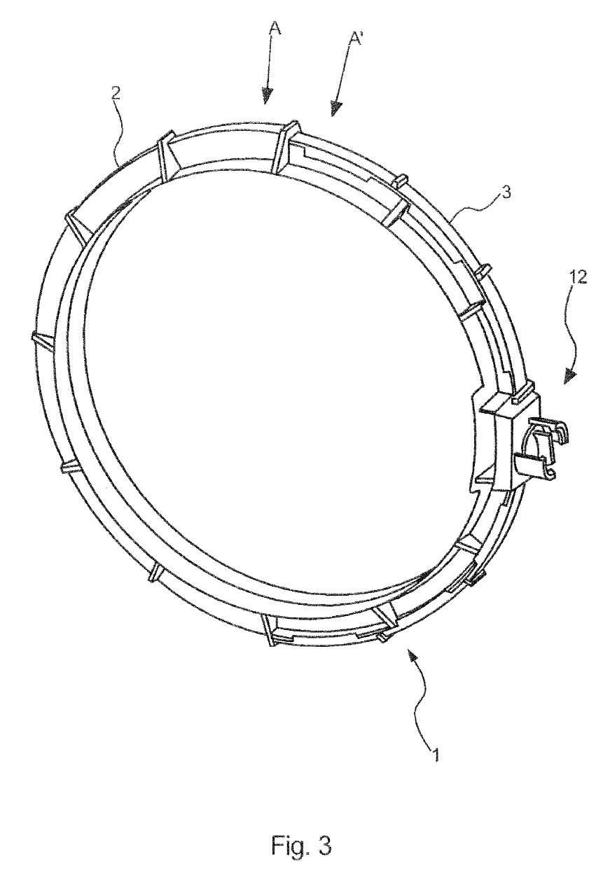

Joining the first connecting element 2 to the second connecting element 3 will be explained in more detail below with reference to FIG. 2 and FIG. 3.

These show a view of the connection system 1, respectively before and after it is joined. The connection system 1 reduces the space required when the elongate hollow bodies are installed and uninstalled, since no clamps or flanges are provided. As a result it becomes possible to join the two elongate hollow bodies laterally, as indicated in FIG. 2 by the arrow 13.

In this case, lateral joining is performed in a radial direction, that is to say transversely to the longitudinal axis of the elongate hollow bodies. This type of assembly of the connection system 1 requires only a small space, since no assembly accessories, for example, need to be guided around and applied to the elongate hollow bodies in the joined condition. Furthermore, after installation the two hollow bodies can no longer be twisted in relation to one another, since there are no circular components such as clamps or brackets. As can be seen from FIG. 3, the flange-like connection system 1 requires only a small amount of space in the fully joined condition and may also be made by means of an injection moulding method to be lightweight, such that for example when pipes are used in an aircraft there is no possibility of the resonant frequencies creating a nuisance at low frequencies.

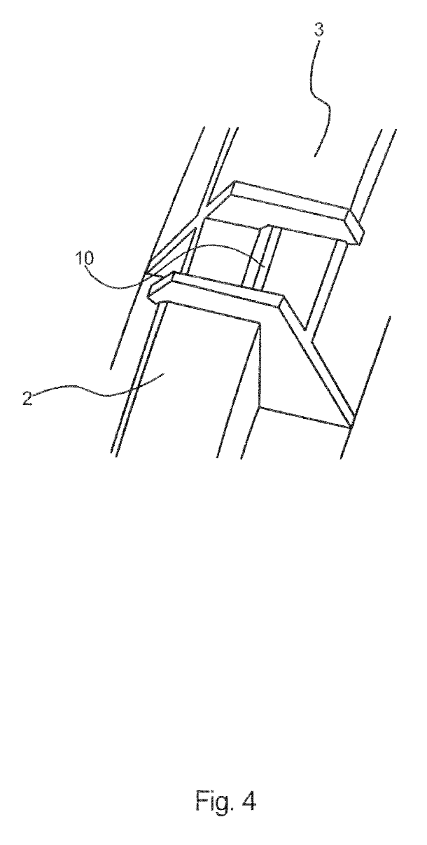

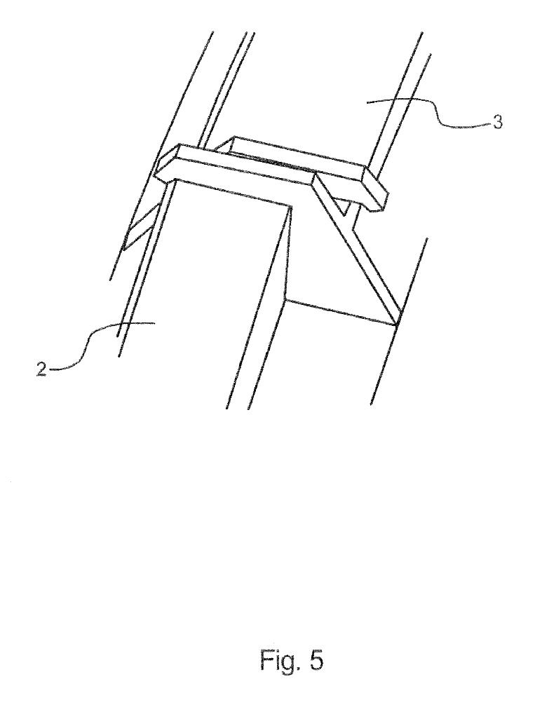

The joining will be explained once again by means of a detail view, with reference to FIGS. 4 and 5. This shows a detail view from the outside in the radial direction towards the region in which the first connecting element 2 and the second connecting element 3 abut against one another. This region is marked by the arrows A and A′ in FIG. 3.

Visible between the first connecting element 2 and the second connecting element 3 is the gasket 10. The projecting element 6 and the recess 7 are shaped as guides such that when they are pushed together an axial offset is produced in the direction of the hollow body. In this way, friction between the first connecting element 2 and the second connecting element 3 is reduced.

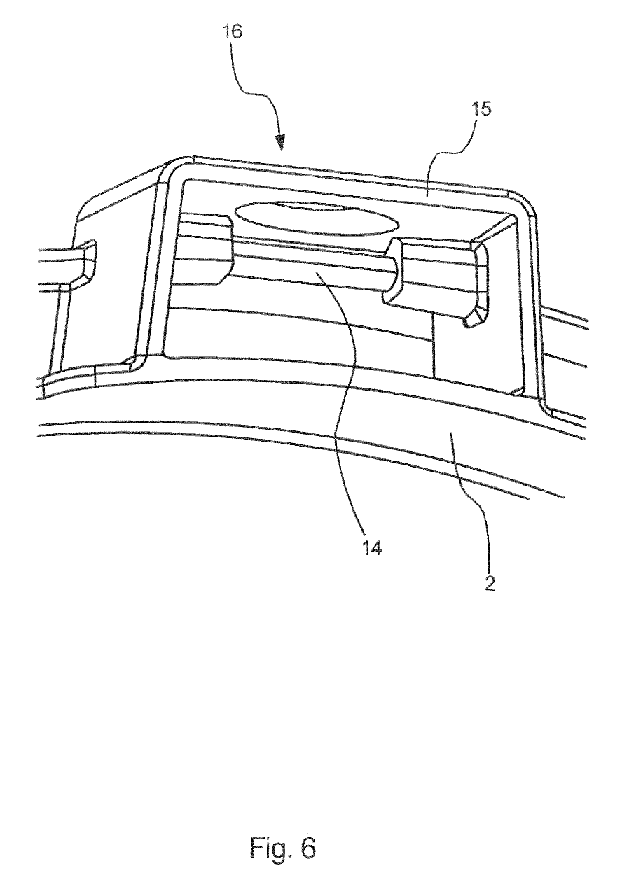

An embodiment of the locking means 12 will be explained below with reference to FIGS. 6 to 8. The locking means 12 comprises two components. The first component is arranged on the first connecting element 2 and includes a wire 14 which lies within a U-shaped profile 15 that has an opening 16 above the wire 14, as shown in FIG. 6. FIG. 6 shows a side view of the first connecting element 2, corresponding approximately to the region B-B′ shown in FIG. 2.

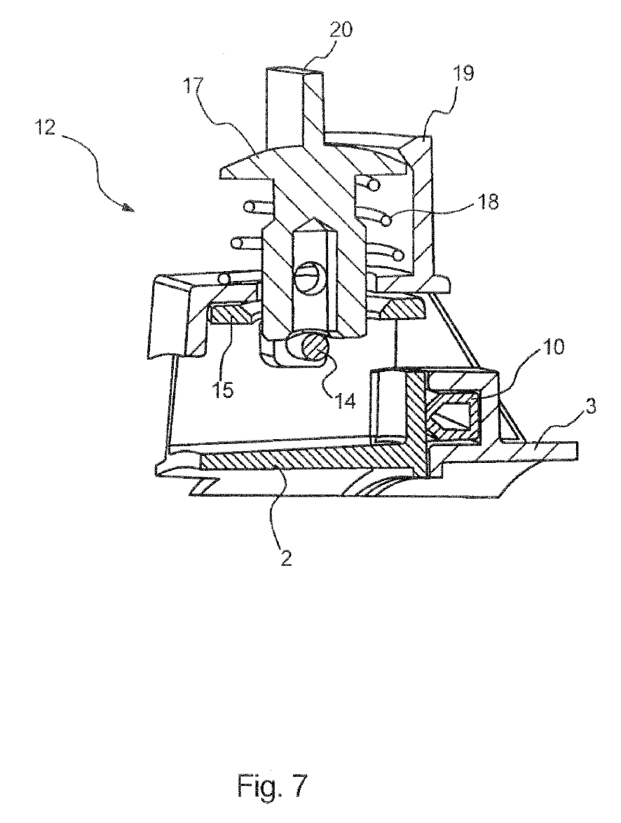

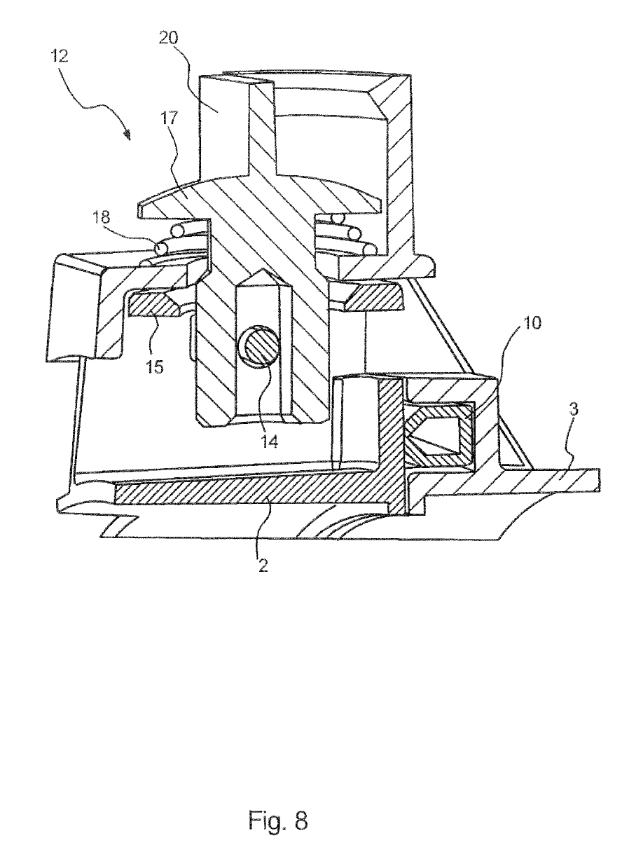

The second component is arranged on the second connecting element 3 and includes a quarter-turn lock 17 having a conical spring 18 which can engage, above the U-shaped profile 15, in the wire 14, as shown in FIGS. 7 and 8. FIGS. 7 and 8 show the locking means 12 in a cross-sectional view before and after locking, along a line of section C-C′ as indicated in FIG. 1. The quarter-turn lock 17 is arranged in a housing part 19 and has on the outer side a wing-head element 20 such that the locking means 12 may be operated without tools, by way of the wing-head element 20. For this, the quarter-turn lock 17 may be arranged in the direction of installing and uninstalling, in order to facilitate operation during assembly.

The quarter-turn lock 17 has on the underside a hook-shaped element (not shown explicitly in FIG. 7 or 8) which as a result of being turned can reach into the wire in order to make a secure connection. At the same time, the conical spring 18 provides for a restoring force, such that if the quarter-turn lock 17 does not engage fully it springs into the open position. This directly indicates to the user that locking has not been performed.

Furthermore, the conical spring 18 generates a force for compression of the first connecting element 2 and the second connecting element 3. The force generated in this way may be 20 N, for example, and may be determined by way of the choice of spring force of the conical spring 18.

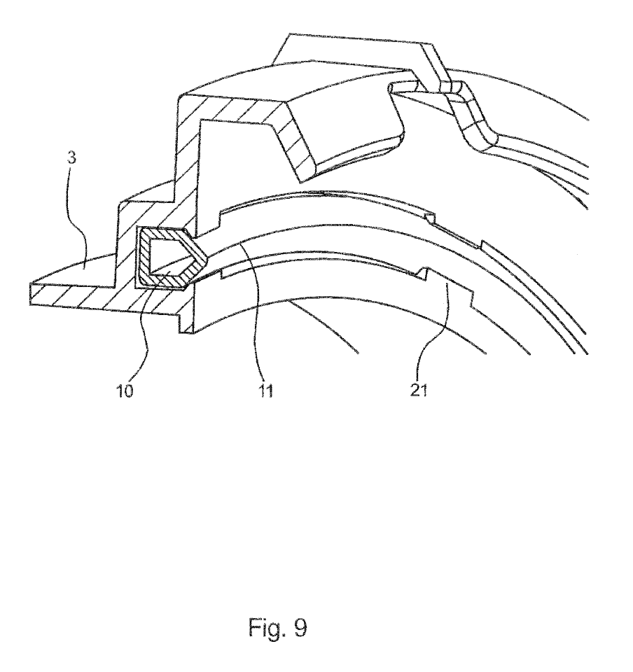

Installation of the gasket 10 in the second connecting element 3 will be explained below with reference to FIG. 9. FIG. 9 shows a cross-section through the second connecting element 3. As can be seen from FIG. 9, the gasket 10 is introduced into a housing opening in the second connecting element 3 such that its sealing surface 11 is directed outwards. The gasket 10 may be formed as an extruded hollow body, preferably of silicone. The gasket 10 is held in the housing opening by projections 21. Overall, the projections 21 have the effect of producing an undercut opening. This ensures that the gasket 10 cannot fall out during assembly. Further, the gasket 10 is fully compressed only once the locking means 12 is in the closed position.

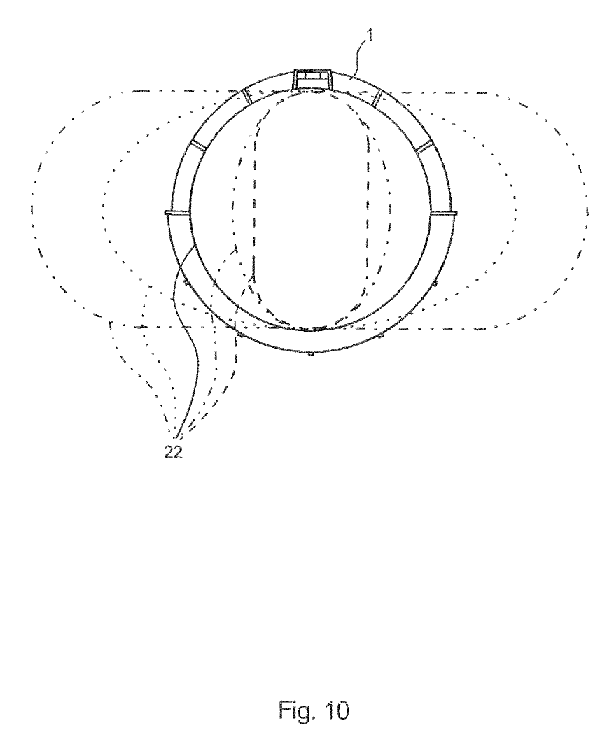

The connection system 1 is suitable for a number of elongate hollow bodies. As shown in FIG. 10, the elongate hollow bodies 22 may be of circular or elliptical cross section. However, it is also provided for them to take the form of a shallow duct. In this arrangement, the locking means 12 may equally be arranged on the shorter or on the longer side of the elongate hollow bodies 22.

According to the invention, a method for connecting two elongate hollow bodies is also provided. In a first step, the method comprises providing a first connecting element 2 which includes a projecting element 6 which is arranged in a radial direction. A second connecting element 3 which includes a recess 7 corresponding to the projecting element 6 is provided. Once the first connecting element 2 and the second connecting element 3 have been mounted on mutually facing ends of elongate hollow bodies 22, the first connecting element 2 and the second connecting element 3 are pushed together in a radial direction 13.

Between the first connecting element 2 and the second connecting element 3 there is arranged a locking means 12. In a last step, the locking means 12 is then closed such that a detachable connection is made between the first connecting element 2 and the second connecting element 3.

The invention may also advantageously be used in an aircraft cabin including pipes or shallow ducts which are at least in some cases provided with a connection system 1. Furthermore, the invention may also be used in an aircraft having an air conditioning system which includes pipes or shallow ducts which are at least in some cases provided with a connection system 1.

### LIST OF REFERENCE NUMERALS

1 Connection system
2 First connecting element
3 Second connecting element
4 First inner face
5 Second inner face
6 Projecting element
7 Recess
8 Further recess
9 Further projecting element
10 Gasket
11 Sealing surface
12 Locking means
13 Radial direction
14 Wire
15 U-shaped profile
16 Hole
17 Quarter-turn lock
18 Conical spring
19 Housing part
20 Wing-head element
21 Projection
22 Elongate hollow body

1. A connection system for elongate hollow bodies, including a first connecting element and a second connecting element which may be mounted on mutually facing ends of elongate hollow bodies, wherein the first connecting element includes at least one projecting element which is arranged in a radial direction and, in the event of being pushed together, may be introduced into a corresponding recess in the second connecting element, wherein between the first connecting element and the second connecting element there is arranged a locking means which provides a detachable connection between the first connecting element and the second connecting element ROM.

2. The connection system according to claim 1, wherein the projecting element covers part of the outer periphery of the first connecting element.

3. The connection system according to claim 1, wherein the first connecting element has on its outer edge, outside the projecting element, a further recess into which a corresponding further projecting element on the second connecting element may be introduced.

4. The connection system according to claim 1, wherein the projecting element and the recess are shaped such that when they are pushed together an axial offset is produced in the direction of the hollow body in order to reduce friction between the first connecting element and the second connecting element.

5. The connection system according to claim 1, wherein on the second connecting element there is mounted a gasket whereof a sealing surface faces the first connecting element.

6. The connection system according to claim 5, wherein the gasket is clamped in an undercut opening in the second connecting element.

7. The connection system according to claim 5, wherein the gasket is formed as an extruded hollow body.

8. The connection system according to claim 1, wherein the locking means includes a quarter-turn lock arranged on the second connecting element.

9. The connection system according to claim 8, wherein the quarter-turn lock reaches into an elongate body, which is arranged in an outer region of the first connecting element.

10. The connection system according to claim 1, wherein the elongate hollow bodies are of circular or elliptical cross-section or take the form of a shallow duct.

11. The connection system according to claim 1, wherein the first connecting element and the second connecting element may be made by means of an injection moulding method.

12. The connection system according to claim 1, wherein the first connecting element and the second connecting element are connected to the elongate hollow bodies by means of an adhesive.

13. An aircraft cabin having pipes or shallow ducts which are at least in some cases provided with a connection system according to claim 1.

14. An aircraft having an air conditioning system which includes pipes or shallow ducts which are at least in some cases provided with a connection system according to claim 1.

15. A method for connecting two elongate hollow bodies, comprising:
providing a first connecting element, wherein the first connecting element includes at least one projecting element which is arranged in a radial direction;
providing a second connecting element, wherein the second connecting element includes a recess corresponding to the projecting element;
mounting the first connecting element and the second connecting element on mutually facing ends of elongate hollow bodies;
pushing the first connecting element and the second connecting element together in a radial direction, wherein between the first connecting element and the second connecting element there is arranged a locking means which makes a detachable connection between the first connecting element and the second connecting element; and
closing the locking means.

16. The connection system according to claim 1, wherein said elongate hollow bodies are pipes or shallow ducts in an aircraft.

17. The connection system according to claim 2, wherein the projection element covers over one side of the outer periphery of the first connecting element.

18. The connection system of claim 7, wherein the gasket is formed of silicone.

19. The connection system according to claim 9, wherein the elongate body is a wire.

20. The method according to claim 15, wherein the two elongate hollow bodies are pipes or shallow ducts in an aircraft.
